(19) United States
(12) Patent Application Publication
(10) Pub. No.: US 2003/0179590 A1
(43) Pub. Date: Sep. 25, 2003

(54) Decorative illuminated pumpkin stems

(76) Inventor: John Raymond Wyss, Seattle, WA (US)

Correspondence Address: JOHN R. WYSS, c/o 9020 GREENWOOD AVE. N., SEATTLE, WA, 98103, US

(21) Appl. No.: 10/328,983

(22) Filed: Dec. 26, 2002

Related U.S. Application Data
(63) Continuation-in-part of application No. 09/905,821, filed on Jul. 16, 2001, now Pat. No. 6,513,945.

(51) Int. Cl. A01N 1/00

(52) U.S. Cl. 362/565; 428/15

(57) ABSTRACT

This invention is in the area of three-dimensional holiday decorations and their manufacture, and specifically in the area of an illuminated decoration to replace natural stems for the tops of pumpkins, squash and gourd-type fruits as used in Halloween, Thanksgiving, Harvest, Christmas and similar holiday-type decorations. An artificial replacement stem and various assorted appendages such as witches and apparitions are provided.

A decorative Halloween pumpkin is affixed with said artificial stem or various appendages of a festive design, replacing its natural stem. Said artificial stem or appendage is equipped with means of illumination by chemical luminescence, together with a means for affixing said artificial stem or appendage to said pumpkin by a spike or hook-type attachment means.

### BACKGROUND OF THE INVENTION

This invention is in the area of three-dimensional holiday decorations and their manufacture, more specifically, an illuminated decoration replacing a natural stem on the top of a pumpkin, squash or gourd-type fruit of the type used in Halloween, Thanksgiving, Harvest, Christmas and similar holiday-type decorations. Methods of creating artificial pumpkins for decoration are taught in U.S. Pat. Nos. 5,491,007 & No. 5,811,160, both by Chapman. The subject invention deals specifically with creation of an artificial stem, replacing a natural stem.

Said natural stems may not be present or may be removed from a natural pumpkin or like fruit. In U.S. Pat. No. 5,099,604, Gallo teaches an artificial stem for flowers which acts as a feeder tube for water to reach a cut flower. That concept for an artificial stem is primarily to help a cut flower live longer, in part by capillary action, providing the cut flower with moisture. The present concept is primarily for decorative purposes, and does not aid in the life support of the cut pumpkin, squash or like fruit.

Chemically activated luminescence is very well explained in various patents, such as U.S. Pat. No. 3,576,987 by Voight, et al, a light stick device, and further in U.S. Pat. No. 5,043,851, by Kaplan, entitled “Polygonal Chemiluminescent Lighting Device”, describing a polygonal design in a chemiluminescent lighting device. This device is incorporated in the preferred embodiment of this invention.

Paniaguas, et al, U.S. Pat. No. 5,091,833 shows decorative lighting displays upon a pumpkin body, and Bardeen, et al, U.S. Pat. No. 6,309,092 shows a way to illuminate a pumpkin interior. Franks, U.S. patent application No. 20010036069, has constructed a stem-like hanging device to illuminate the pumpkin interior. Other art of note is disclosed in Spector, U.S. Pat. No. Re. 30,103; Zingale, et al, U.S. Pat. No. 6,106,135; Palmer, et al, U.S. Pat. No. 6,065,847; Kaboske, U.S. Pat. No. 5,313,377.

All have used various lighting devices in a decorative display, but fall short of providing an easily affixed and chemically illuminated artificial replacement stem for a pumpkin which is illuminated and illuminates the pumpkin interior, or derives its lighting from a chemiluminescent light source within the pumpkin interior volume, to be used as decorative centerpieces or adornments in homes, businesses and stores.

Prior art falls short of providing decorative appendages, displayed upon a pumpkin, making use of decorative holiday themes, designs and apparitions which are illuminated and illuminate the pumpkin interior, or derive its lighting from a chemiluminescent light source within the pumpkin interior volume.

### SUMMARY OF THE INVENTION

It is an object of the invention to provide a replacement for missing or removed stems of the variety found naturally on the fruit of the pumpkin, squash or gourd.

It is a further object of the invention to provide an appendage for a pumpkin as mentioned in which illumination means are provided to enhance the decorative nature of the appendage and of the interior volume of the pumpkin.

It is a further object to provide various decorative appendages as stem replacements having means of illumination, and means of illumination of the interior volume of the pumpkin.

The above and other objects of the invention are achieved in the following disclosed embodiments by providing an attachable artificial appendage comprising a stem piece or a stem-like body having the appearance of a decorative holiday theme, an apparition or the like.

Said artificial appendage piece may be made from a choice of a wide variety of materials, for example, plastic, glass, acrylic or many other translucent, reflective or decorative-type materials.

It is a purpose to provide means of creation of a decorative lighted artificial stem constructed with the use of chemically luminescent materials, designed to be light emitting, reflecting or chemiluminescent in order to provide a festive decoration. Means for attachment to the pumpkin or the like are provided, at or about the spot where the natural stem would have protruded. The said attachment means being by either or both an adhesive or spike which inserts through the fruit, and once inserted is designed to affix into the natural shell of the main body of the said pumpkin or the like.

It is a purpose to provide a lighted spike which can be affixed by similar means into the interior volume on a typical pumpkin, gourd or like-type fruit, so that light shines through the carved holes of a holiday “jack-o-lantern” for decorative purposes, as well as lighting the said decorative appendage on top of the “jack-o-lantern”.

It is a further purpose to provide decorative adornments and apparitions to enhance the decorative or holiday appearance of the natural fruits on display, and to provide those adornments with illumination such that said adornments will show and be displayed in the dark.

Those skilled in holiday design and decoration will appreciate and be able to derive a vast array of embodiments of the art after reviewing the following detailed description of the invention.

The replacement “stems” with illumination can take a variety of shapes, sizes and forms. They may be small characters such as ghosts, witches, animals or any suitable apparition, letter or number, word or words, display, poster, sign, advertisement, message or alert signal. All of which may be constructed in a number of known or inventive ways.

### BRIEF DESCRIPTION OF THE DRAWINGS

FIG. 1 Decorative Appendage with Illumination Means

FIG. 2 Method of Simultaneous Illumination of Decorative Appendage and Interior Volume Space of Pumpkin

### DETAILED DESCRIPTION

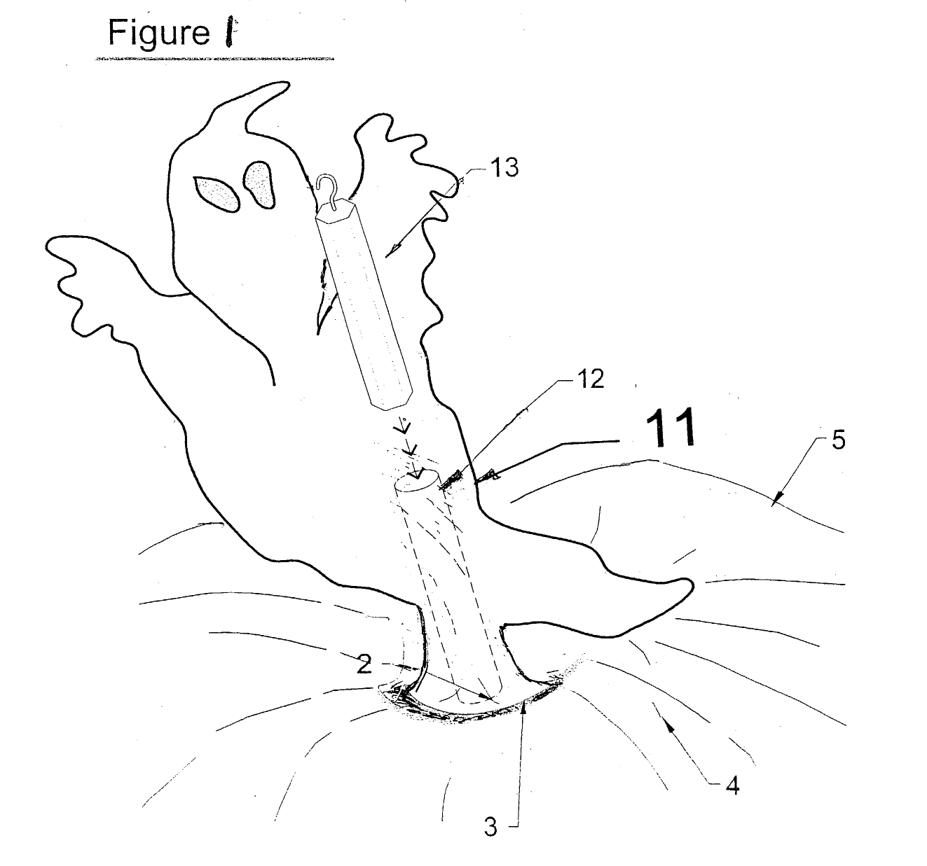

FIG. 1 shows a translucent or transparent artificial appendage in the form of a ghostly apparition (11) prepared for attachment to a pumpkin (5). In this embodiment, adhesive (2) is applied to the proposed point of application at the base of the stem (3), the entire assembly to be affixed at the approximate location of the pumpkin's natural stem (4), now removed.

Said translucent or transparent artificial appendage has been modified with a cavity (12), enabling the insertion of a tubular shaped chemiluminescent lighting device (13) such as the kind described in U.S. Pat. No. 5,043,851, by Kaplan, entitled “Polygonal Chemiluminescent Lighting Device”, or any other chemiluminescent device commonly known as a “light stick”, a well known lighting device which is activated by a combination of two chemicals which react when combined, and temporarily generate various colors of chemiluminescent light, thereby shining through the stem, illuminating the appendage (11). The lighting device (13) rests inside of the cavity (12), and since this display would normally be in an upright position at the top of a pumpkin, said lighting device (13) does not fall out or move from its location.

Attachment of the appendage (11) by hook or spike or other known method would be equivalent to gluing the appendage (11) by its base (3) onto the pumpkin at the approximate location of the pumpkin's natural stem (4).

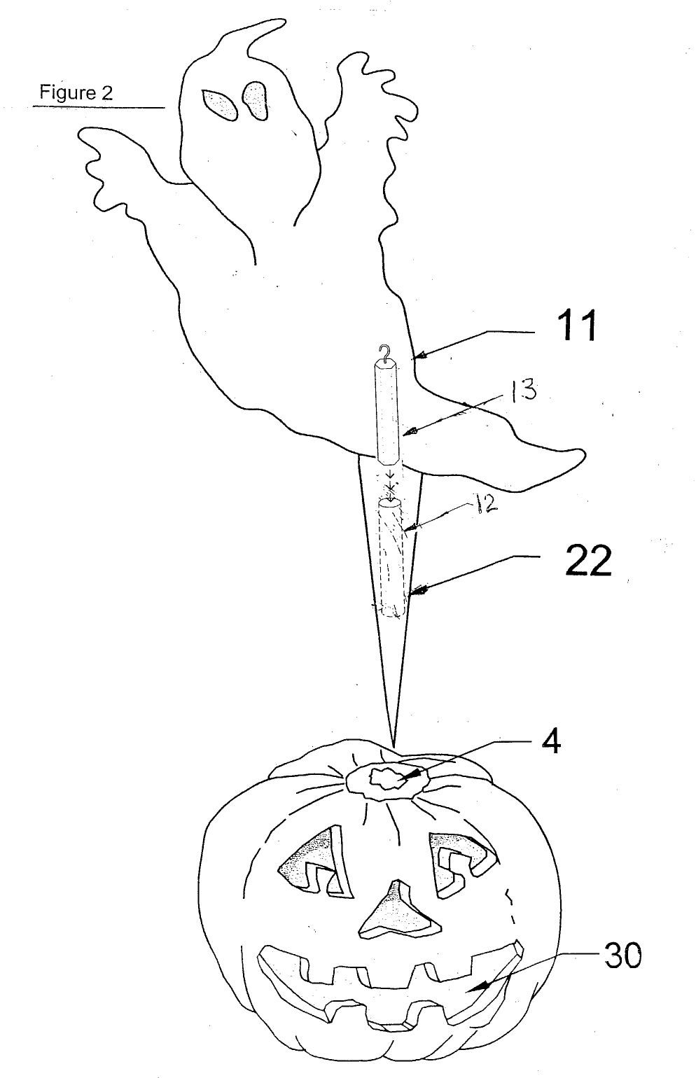

FIG. 2 shows a translucent or transparent appendage, a decorative stem replacement in the form of a ghostly apparition (11), for attachment to a pumpkin (5). Said elongated base (22) has been modified with a cavity (12), enabling the insertion of a tubular shaped chemiluminescent lighting device (13), such as the kind described in FIG. 1.

This embodiment extends downward with an elongated base (22), shown as a pointed base in this embodiment, formed of an optically transparent glass or acrylic, similar to the appendage (11), and is integral by attachment to the appendage (11) such that light generated in the lighting device (13) within the cavity (12) in the elongated base (22) is visibly emitted into and by the appendage (11) by the natural optical transfer of light between transparent or translucent compounds.

Attachment to said pumpkin is affected by insertion of the pointed tip of said elongated base (22) into the pumpkin's hollow interior volume space (30), such that the elongated base and its lighting device are contained within the pumpkin's hollow interior volume space (30), whereby light generated in the lighting device (13) within the cavity (12) in the elongated base (22) is visibly emitted into the pumpkin's hollow interior by the illumination emitted by said lighting device (13).

FIG. 2 shows the pointed elongated base in a position prior to attachment, above a corresponding opening in the pumpkin's upper surface (4), at the approximate location of the pumpkin's natural stem, now removed.

The appendage (11) and elongated pointed base (22), all made of a translucent or semitransparent optical material, tend to simultaneously emit light generated by said lighting device (13).

In this embodiment, with light source (13) inserted into cavity (12) in elongated base (22), and elongated pointed base (22) inserted into the pumpkin's hollow interior, said light source (13) casts a glow within the interior volume space (30), and simultaneously casts reflective light outwardly from the said decorative appendage's upper portion (11). Thus, both decorative appendage (11) and the pumpkin's hollow interior volume space (30) are simultaneously illuminated by the light emitted from the light source (13) contained therein.

Attachment by hook, wire or spike or other known methods is anticipated, to add structural integrity to the assembly.

Other various holiday designs, a cat, a baby pumpkin, a bat and a moon, and any variety of festive figures or designs are suitable to such a decorative purpose and numerous ways to decorate the fruit are anticipated. Even a sign with words, numbers, symbols or messages can be displayed in this manner, as said replacement stem, and such use is anticipated.

What is claimed is:

1) An artificial appendage assembly for a pumpkin, said assembly comprising a body having a cavity for insertion of a lighting device, a lighting device such that said lighting device rests within said cavity, thereby lighting said body of said appendage, a base and means for attachment of said assembly to a surface of a pumpkin.

2) An artificial appendage of claim 1 wherein said appendage is transparent.

3) An artificial appendage of claim 1 wherein said appendage is translucent.

4) An artificial appendage assembly for a pumpkin, said assembly comprising a body and an elongated base for insertion into the interior volume space of said pumpkin, said elongated base having a cavity for insertion of a lighting device, whereby said lighting device rests within said cavity in said elongated base, thereby simultaneously lighting said interior volume space and said body of said appendage.

5) An artificial appendage of claim 4 wherein said appendage and elongated base is transparent.

6) An artificial appendage of claim 4 wherein said appendage and elongated base is translucent.
